(19) United States
(12) Patent Application Publication
(10) Pub. No.: US 2015/0025861 A1
(43) Pub. Date: Jan. 22, 2015

(54) GENETIC SCREENING COMPUTING SYSTEMS AND METHODS

(71) Applicant: THE JOHNS HOPKINS UNIVERSITY, Baltimore, MD (US)

(72) Inventors: Rachel Karchin, Towson, MD (US); Yun-Ching Chen, Hsinchu (TW)

(21) Appl. No.: 14/333,612

(22) Filed: Jul. 17, 2014

Related U.S. Application Data
(60) Provisional application No. 61/847,162, filed on Jul. 17, 2013.

(51) Int. Cl. G06F 19/12

(52) U.S. Cl. CPC G06F 19/12
USPC 703/2

(57) ABSTRACT

Various techniques are disclosed that allow phenotype-related data to be aggregated from any number of online sources. A statistical model may be generated using the aggregated data that, based on (epi)genome, microbiome, or other omics information regarding a subject, predicts the probability of the subject having the phenotype.

### CROSS-REFERENCE TO RELATED APPLICATIONS

This application claims priority to U.S. Provisional Application No. 61/847,162, entitled “SYSTEM AND METHOD FOR BAYESIAN INFERENCE MODEL TO PREDICT PHENOTYPE FROM PERSONAL VARIATION,” and filed on Jul. 17, 2013 by Karchin et al., the contents of which are hereby incorporated by reference.

### BACKGROUND

Interest in the field of personalized health has increased considerably in recent years, primarily due to a number of advances in the fields of (epi)genetics and omics. Efforts such as the Human Genome Project, the 1000 Genomes Project, and other such projects, have led to considerable insight into the potential variations across the human (epi)genome (and microbiome). These projects are typically large-scale and allow hundreds or even thousands of researches across the globe to collaborate.

One key component of personalized health involves performing screening of an individual, to ascertain how likely the individual is to demonstrate a particular phenotype (e.g., a trait, a disease or disorder, etc.). For example, a particular variation may indicate an increased probability of developing a certain type of cancer. However, accurately predicting whether an individual will demonstrate a given phenotype is not without challenges. In particular, whether a subject will actually demonstrate a given phenotype may be affected by a number of factors that may include environmental factors, the effects of multiple (epi)genetic variations on the phenotype, and other such factors. For these and other reasons, developing accurate models to predict the expression of a phenotype by an individual may be challenging and difficult.

### SUMMARY

In one embodiment, a method is disclosed in which a computing device generates a statistical model for a phenotype. The statistical model uses a population prevalence of the phenotype as a prior probability. The computing device receives data regarding a subject and uses the data as input to the statistical model. A probability of the phenotype for the subject is determined by the statistical model. The probability of the phenotype for the subject is provided by the computing device.

In another embodiment, an apparatus is disclosed. The apparatus includes one or more network interfaces to communicate with a network, a processor coupled to the network interfaces and adapted to execute one or more processes, and a memory configured to store a process executable by the processor. When executed, the process is operable to generate a statistical model for a phenotype that uses a population prevalence of the phenotype as a prior probability. The process is also operable to receive data regarding a subject the subject and use the data as input to the statistical model. The process is further operable to determine a probability of the phenotype for the subject. The process is additionally operable to provide the probability of the phenotype for the subject.

In yet another embodiment, a tangible, non-transitory, computer-readable media having software encoded thereon is disclosed. When executed by a processor, the software is operable to generate a statistical model for a phenotype that uses a population prevalence of the phenotype as a prior probability. The software is further operable to receive data regarding a subject and to use the data as input to the statistical model. The software is additionally operable to determine a probability of the phenotype for the subject. The software is also operable to provide the probability of the phenotype for the subject.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computing system;

FIG. 2 illustrates an example computing device;

FIG. 3 illustrates an example architecture to generate a phenotype prediction for a subject;

FIG. 4 illustrates an example statistical model;

FIG. 5 illustrates an example categorization of genetic variation data associated with a phenotype;

FIG. 6 illustrates an example of a statistical model being generated;

FIG. 7 illustrates an example simplified procedure for predicting the expression of a phenotype by a subject; and

FIG. 8 illustrates an example simplified procedure for generating a statistical model.

In the figures, reference numbers refer to the same or equivalent parts of the present invention throughout the several figures of the drawing.

### DETAILED DESCRIPTION

According to various aspects described herein, a predictive model may be generated to predict the probability of a subject demonstrating a given phenotype. In some aspects, the model may be based on data received from varying sources, such as different (epi)genetic and omics databases available via the Internet or other computer networks. The data may be categorized based in part on its source and used to generate a predictive model, such as a Bayesian inference model. Such a model may be used to determine the probability of a particular subject demonstrating a particular phenotype based on the (epi)genome and/or microbiome of the subject.

### I. DEFINITIONS

Unless defined otherwise, all technical and scientific terms used herein have the meaning commonly understood by a person skilled in the art to which this invention belongs. The following references provide one of skill with a general definition of many of the terms used in this invention: Singleton et al., Dictionary of Microbiology and Molecular Biology (2nd ed. 1994); The Cambridge Dictionary of Science and Technology (Walker ed., 1988); The Glossary of Genetics, 5th Ed., R. Rieger et al. (eds.), Springer Verlag (1991); and Hale & Marham, The Harper Collins Dictionary of Biology (1991). As used herein, the following terms have the meanings ascribed to them unless specified otherwise.

Unless otherwise specified, “a” or “an” means “one or more”.

Unless specifically stated or obvious from context, as used herein, the term “or” is understood to be inclusive.

As used herein, the terms “comprises,” “comprising,” “containing,” “having” and the like can have the meaning ascribed to them in U.S. Patent law and can mean “includes,” “including,” and the like; “consisting essentially of” or “consists essentially” likewise has the meaning ascribed in U.S. Patent law and the term is open-ended, allowing for the presence of more than that which is recited so long as basic or novel characteristics of that which is recited is not changed by the presence of more than that which is recited, but excludes prior art embodiments.

As used herein, the term “subject” is meant to refer to an animal, preferably a is mammal including a non-primate (e.g., a cow, pig, horse, cat, dog, rat, mouse, etc.) and a primate (e.g., a monkey, such as a cynomolgous monkey, and a human). In a preferred embodiment, the subject is a human.

The term “phenotype” is generally meant herein to refer to an observable characteristic or trait of a subject. For example, a given phenotype may correspond to a particular disease or disorder that affects a subject.

As used herein, the term “variant” refers to a genetic difference between subjects within a population. For example, a variant may be a set of one or more single nucleotide polymorphisms (SNPs) and may include epigenomic or microbiome variations.

As used herein, the term “penetrance” is meant to refer to a measure of the number of members of a population that exhibit a particular phenotype and share a common genetic characteristic (e.g., gene or variant). For example, the penetrance of a particular variant may be 80%, if only 80% of subjects that have the variant express the phenotype.

### II. SYSTEM OVERVIEW

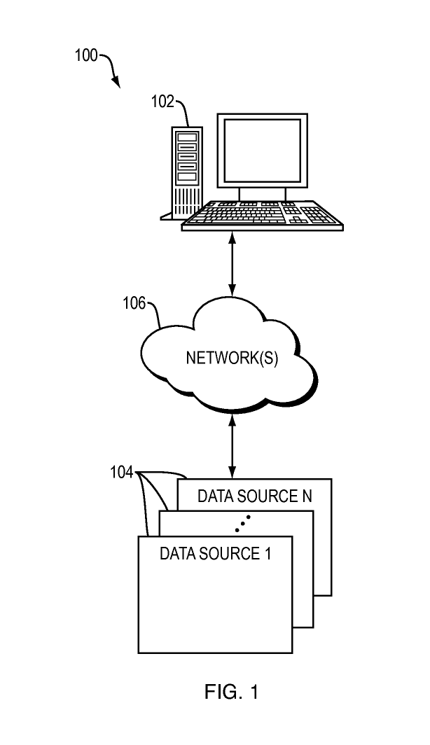

FIG. 1 illustrates an example computer system 100 for performing genetic screening of a subject, according to various embodiments. As shown, any number of computing devices 102-104 may communicate with one another via one or more networks 106. As will be appreciated, networks 106 may include, but are not limited to, local area networks (LANs), wide area networks (WANs), the Internet, cellular networks, infrared networks, or any other form of network configured to convey data between computing devices. Networks 106 may also include any number of wired or wireless links between computing devices 102-104 and any intermediary devices that support the operations of networks 106. For example, a computing device may communicate wirelessly with an access point that is wired to a larger network, such as the Internet.

In various embodiments, computing device 102 may be one or more computing devices configured to determine a probability of a subject exhibiting a particular phenotype based on data regarding the (epi)genome and/or microbiome of the subject. In some cases, computing device 102 may generate a predictive model based on information received from any number of data sources 104 (e.g., a first through nth computing device configured to communicate with computing device 102 via networks 106). For example, during operation, computing device 102 may retrieve genetic information available from any number of online databases or other resources that contain genetic information associated with a particular phenotype as part of data sources 104. Such information may then be used by computing device 102 to generate a predictive model which, given data regarding the personal (epi)genome and/or microbiome of a subject, is operable to generate a probability of the subject demonstrating the phenotype.

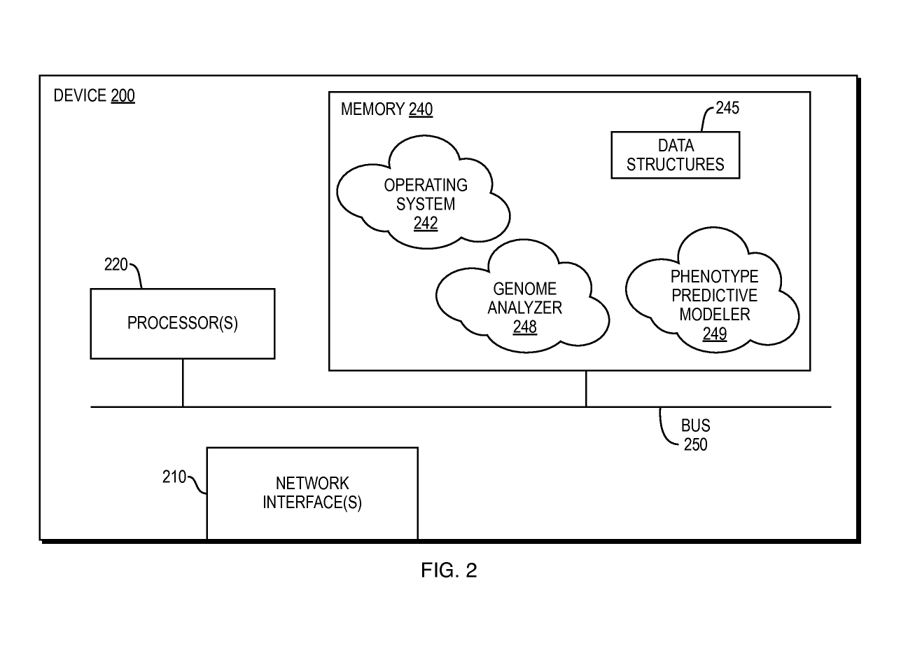

FIG. 2 is a schematic block diagram of an example device 200 that may be used with one or more embodiments described herein, e.g., as any of the devices 102-104 shown in FIG. 1. Device 200 may comprise one or more network interfaces 210 (e.g., wired, wireless, etc.), at least one processor 220, and a memory 240 interconnected by a system bus 250.

The network interface(s) 210 contain the mechanical, electrical, and signaling circuitry for communicating data with other computing devices in system 100. The network interfaces may be configured to transmit and/or receive data using a variety of different communication protocols. Note, further, that device 200 may have two different types of network connections, e.g., wireless and wired/physical connections, and that the view herein is merely for illustration.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, inter alia, invoking operations in support of software processes and/or services executing on the device. These software processes and/or services may comprise a genome analyzer process 248 and a phenotype predictive modeler 249, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

Genome analyzer process 248 contains computer executable instructions executed by the processor 220 to perform any or all of the functions described above with respect to system 100 regarding the analysis of data associated a particular subject (e.g., by analyzing (epi)genome and/or microbiome data). For example, genome analyzer process 248 may receive information regarding a particular subject, such as demographics information regarding the subject, the personal (epi)genome and/or microbiome of the subject (e.g., genetic information regarding the subject), or other such information.

Phenotype predictive modeler 249 contains the computer executable instructions executed by the processor 220 to perform any or all of the functions described above with respect to system 100 regarding the modeling of the presence of a phenotype. In some aspects, modeler 249 may be based on data aggregated from any number of data sources 104, such as academic publications, genetic databases, etc. Any number of predictive models may be generated by modeler 249, in various embodiments. For example, modeler 249 may utilize artificial neural networks (ANNs), machine learning classifiers, regression models, or any other form of machine learning technique, to analyze and predict the demonstration of a phenotype by a subject. In a further embodiment, such a model may be a Bayesian inference model operable to determine the probability of a subject demonstrating a given phenotype.

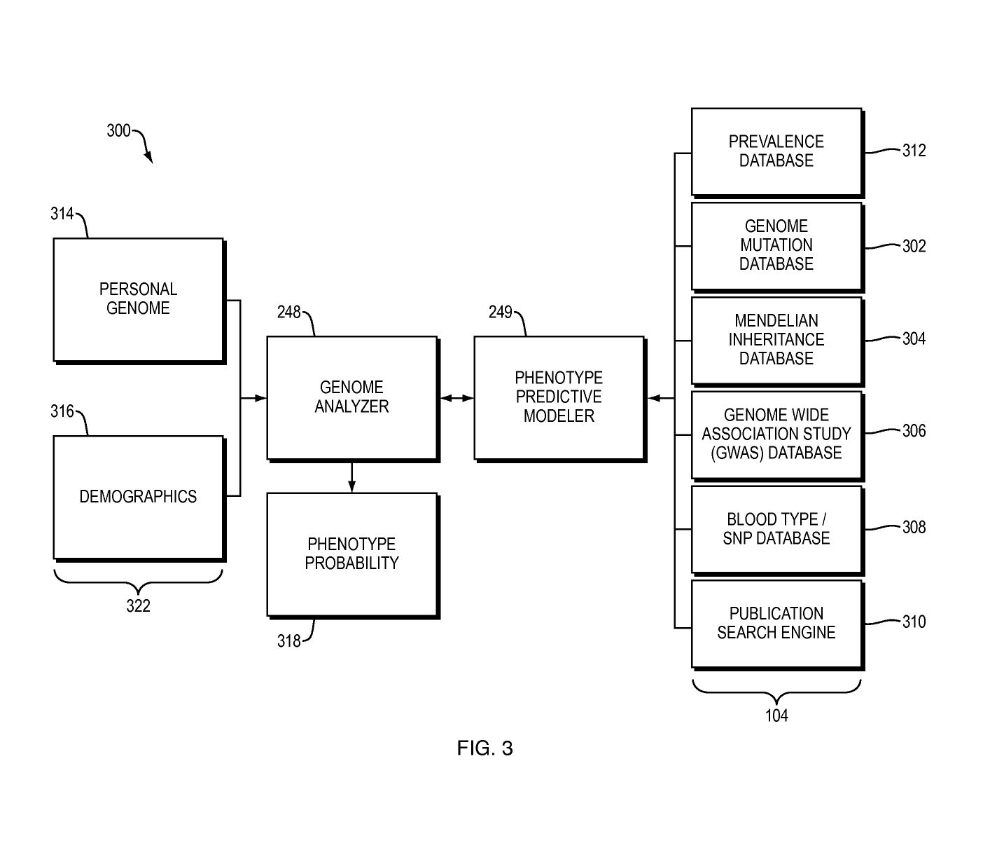

FIG. 3 illustrates an example architecture 300 for generating a phenotype prediction for a subject, according to various embodiments. As shown, genome analyzer 248 and predictive modeler 249 may operate in conjunction to generate phenotype probability 318. Generally speaking, probability 318 represents the probability that, given information 322 regarding a subject (e.g., the personal genome 314 and/or demographics 316), the subject exhibits or will exhibit a particular phenotype, such as a disease or other condition. For example, probability 318 may indicate the probability of the subject exhibiting a particular type of cancer (e.g., breast cancer, colon cancer, kidney cancer, etc.), epilepsy, Crohn's Disease, glaucoma, osteoarthritis, Gilbert Syndrome, Grave's Disease, or the like. In other cases, a given condition may be a positive trait of the individual, such as a perfect pitch or athletic ability.

As shown, phenotype predictive modeler 249 may receive data from any number of data sources 104, to generate the predictive model used by genome analyzer 248. For example, as shown, phenotype predictive modeler 249 may receive prevalence data regarding a phenotype from one or more prevalence databases 312. In general, prevalence data indicates the observed number of members of a population that exhibit the phenotype. In some cases, prevalence data stored in prevalence database 312 may be associated with a demographic (e.g., gender, age, ethnicity, etc.). For example, prevalence data from prevalence database 312 may indicate that the prevalence of Crohn's Disease in Northern Europe is between 27-48 per 100,000 individuals.

Data sources 104 may include any number of data sources that provide genotype, (epi)genetic, and/or other -omics data to phenotype predictive modeler 249. In one embodiment, data sources 104 include a genome mutation database 302. An example of such a database is the Human Gene Mutation Database™ (HGMD) available at http://www.hgmd.org/. Genome mutation database 302 may store gene identifiers and/or identifiers for genetic variants. Associated with such information may also be annotations that indicate whether a particular mutation is associated with a particular phenotype. For example, in the HGMD, a gene or variant may be associated with a disease-causing mutation (DM) indicator or with a DM? indicator that indicates a possible/probable link with the phenotype.

In another embodiment, data sources 104 may include a Mendelian inheritance database 304. An example of such a database is the Online Mendelian Inheritance in Man™ database available at http://www.omim.org. Like database 302, database 304 may also store data that associates gene identifiers with known phenotypes. Also similarly, the associations may be strong (e.g., a set of one or more genes is confirmed to cause the phenotype) or weak (e.g., a set of one or more genes is provisionally flagged as possibly causing the phenotype).

In a further embodiment, data sources 104 may include a genome wide association study (GWAS) database 306 that stores data regarding the results of any number of GWASs. An example of such a database is the catalog of genome-wide association studies available from the National Human Genome Research Institute available at www.genome.gov/gwasstudies. In general, a GWAS may be conducted by comparing the genomes of subjects that exhibit a particular phenotype to the genomes of those that do not. Variations that appear in higher percentages in those that exhibit the phenotype are then flagged in the study as potentially causing the phenotype. Accordingly, variant identifiers stored in database 306 may be flagged as potentially causative of a given phenotype. Notably, and in contrast to the data stored in databases 302-304, a GWAS is typically only able to identify which variants are potentially associated with a given phenotype and not the causative genes themselves.

In yet another embodiment, data sources 104 may include a database 308 of single nucleotide polymorphisms (SNPs). An example of such a database is the SNPedia™ database available at http://www.snpedia.com. In some cases, SNPs stored in database 308 may be associated with particular blood groups (e.g., A, B, AB, O), which are known to be of high penetrance.

In various embodiments, data sources 104 may include one or more publication search engines 310. Generally speaking, such a search engine may employ a data mining process to aggregate gene identifies and associated phenotypes from any number of academic publications. An example of such an engine is available at http://diseases.jensenlab.org/Search. In some embodiments, a z-score or other confidence measurement may be associated with a particular gene-phenotype pair.

Phenotype predictive modeler 249 may retrieve data from any or all of data sources 104 in any number of ways. For example, phenotype predictive modeler 249 may execute any number of scripts, to query and receive gene or variant data associated with a particular phenotype from any of databases 302-312. Such queries may also be tailored to the specific search formats used by the respective databases. In other implementations, some or all of the data stored in databases 302-312 may be downloaded by phenotype predictive modeler 249 and analyzed locally.

As will be appreciated, databases 302-312 described herein are exemplary only. In various other embodiments, data sources 104 may include any number of data sources that relate a particular phenotype to a gene or variant in addition to, or in lieu of, databases 302-312. Said differently, phenotype predictive modeler 249 may aggregate gene and/or variant information associated with a particular phenotype from any number of electronic sources. Using such information, phenotype predictive modeler 249 may construct a model (e.g., a Bayesian inference model, etc.) that may be used by genome analyzer 248 to determine phenotype probability 318 based on information 322 regarding a particular subject.

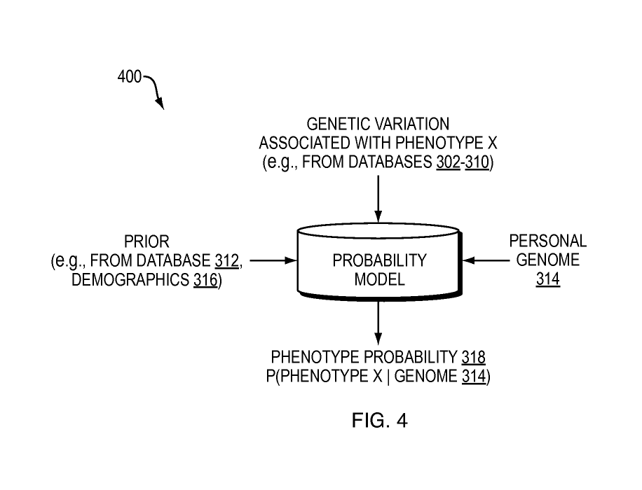

FIG. 4 illustrates an example statistical model 400, according to various embodiments. Such a model may be implemented by genome analyzer 248 and phenotype predictive modeler 249 using data from data sources 104 and subject information 322, as shown in FIG. 3. As output, the model may generate phenotype probability 318, which represents the probability that the subject has phenotype X given the personal genome 314 of the subject.

In some embodiments, model 400 is a Bayesian model that takes as input a base probability that the subject exhibits the phenotype. Also known as a prior probability, this probability may not take into account the personal genome 314 of the subject. In one implementation, a prior probability may be determined using prevalence data from prevalence database 312. For example, the probability that an 85 year old, male subject will develop Parkinson's Disease may be 0.043 without taking into account any genetic information regarding the subject. However, this probability may differ considerably from probability 318 after taking into account the personal genome 314 of the subject in view of the information aggregated from databases 302-310.

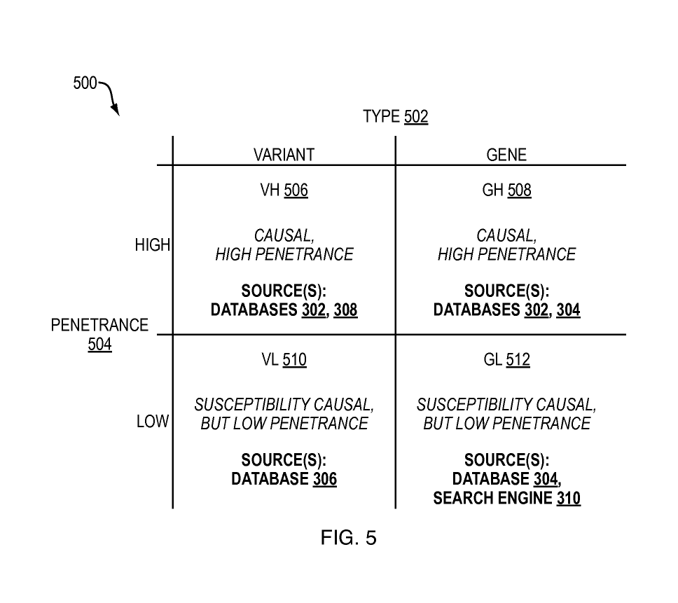

FIG. 5 illustrates an example categorization 500 of genetic variation data associated with a phenotype, according to various embodiments. For example, data from data sources 104 shown in FIG. 3 may be categorized by their respective data sources and information contained therein. The different data categories that result from categorization 500 may be treated differently within the probability model (e.g., model 400 shown in FIG. 4) in various implementations.

As shown, data from the various data sources 104 may be categorized according to their type 502. Type 502 may categorize the data from data sources 104 into either gene-related data or variant-related data. For example, assume that an academic publication crawled by search engine 310 discusses the potential association between a particular gene or set of genes and the phenotype of interest. In such a case, the data may be categorized as being gene-related within categorization 500. Similarly, data regarding a particular variant from GWAS database 306 may be categorized as being variant-related within categorization 500.

In addition to being categorized by type 502, the data from data sources 104 may also be categorized by penetrance 504. As shown, the penetrance 502 of a set of data from data sources 104 may be categorized as being either high penetrance (e.g., a subject that exhibits a particular variant or gene is either guaranteed or likely to exhibit the phenotype) or low penetrance (e.g., the subject having the variant or gene has a lower chance of exhibiting the phenotype). As will be appreciated, further penetrance categories may be used in other implementations, such as low, medium, and high penetrance categories, etc. In other words, the data “bins” depicted are exemplary only and other embodiments may use different bins or, alternatively, no bins at all (e.g., bins may not be necessary if sufficient penetrance information is available).

The divisions between type 502 and penetrance 504 lead to four separate categories: a high penetrance variant (VH) category 506, a high penetrance gene (GH) category 508, a low penetrance variant (VL) category 510, and a low penetrance gene (GL) category 512. According to various embodiments, data from data sources 104 may be placed into categories 506-512 based on the type of information provided (e.g., whether gene or variant information is received from a source), as well as the type of association between the variant/gene and the phenotype (e.g., any flags or annotations associated with the gene or variant(s)). For example, category 506 may include variant data received from database 302 that includes a “DM” annotation. Similarly, data from GWAS database 306 may include variants that were identified as potentially increasing a subject's chances of exhibiting the phenotype, but have not yet been confirmed to cause the phenotype with high penetrance (e.g., GWAS results may be further evaluated to determine whether a particular variant identified in the GWAS should fall within category 506). As noted previously, penetrance estimates may also be more fine-grained, meaning that any or all of categories 506-512 may not be needed as part of the model, in some emboidments.

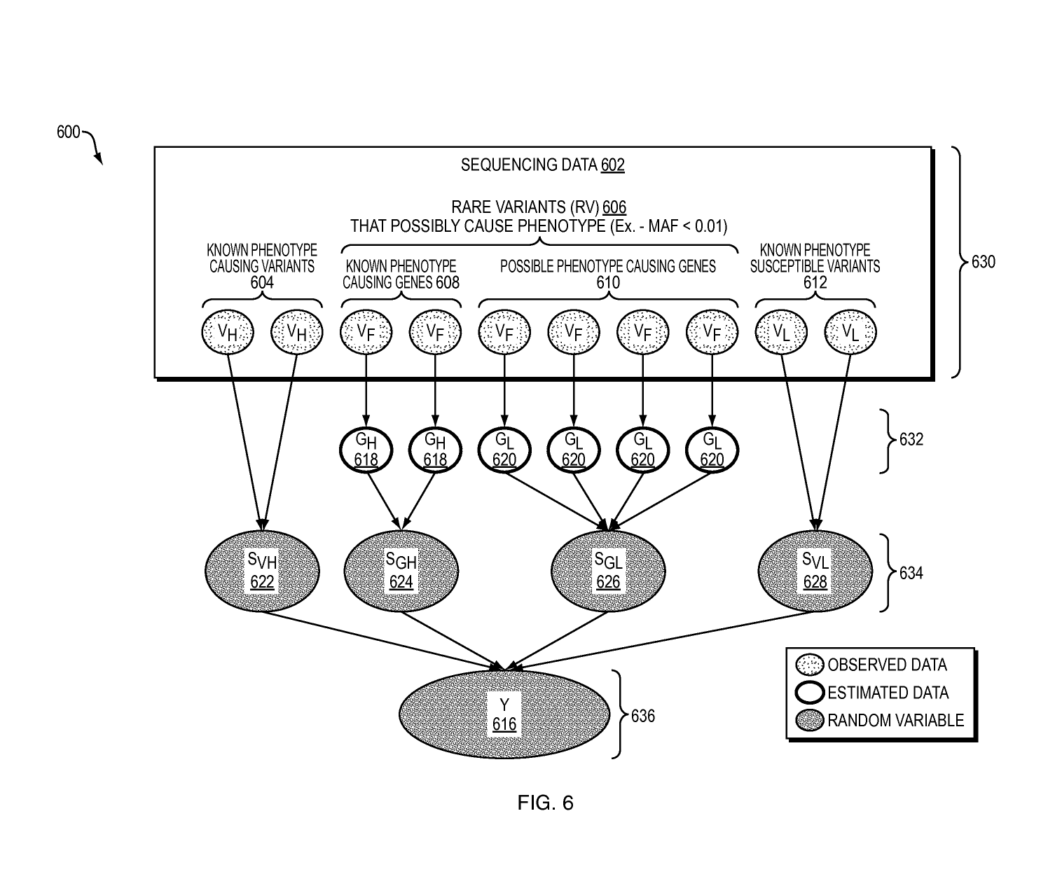

FIG. 6 illustrates an example of a statistical model 600 being generated, according to various embodiments. In particular, data received from data sources 108 may be categorized according to categorization 500, thereby allowing data from different sources to be treated differently within statistical model 600. As shown, model 600 may include the following layers:

Layer 630—The nodes in the first layer represent observed genotypes from an individual's genome (e.g., sequencing data 602 within personal genome 314). In particular, nodes within this layer may represent categorical values that are assigned either a value of 0, 1, or 2, corresponding to a homozygous reference allele, heterozygous allele, or alternate homozygous allele, respectively. These variables may be divided into known phenotype causing variants (high penetrance variants, V_{H}) 604, such as variants annotated as DM in database 302. Layer 630 may also include observed variables 612 corresponding to known phenotype susceptible variants (V_{L}), such as variants identified in GWAS database 306. A third category of variables (V_{F}) 606 in layer 630 may also include any rare variants (RV) that possibly cause the phenotype. Variables 606 may be further subdivided into subcategory 608 associated with known phenotype causing genes and subcategory 610 associated with possible phenotype causing genes. In various embodiments, only rare variants may be considered within model 600 in subcategories 608, 610. For example, only rare variants having minor allele frequencies (MAFs)<0.01 may be considered. Such information may be available, for example, from the 1000 Genomes Project or other similar source.

Layer 632—The nodes 618-620 in this layer represent genes, split into those annotated as high penetrance (G_{H}) or low penetrance (G_{L}), respectively. As shown, nodes 618-620 may be estimated probabilities that a given gene is affected by a rare variant 606. In other words, only genes whose translated products were bioinformatically predicted to be functionally altered by the V_{F} genotypes may be included. In various embodiments, the values of nodes 618-620 may be estimated as follows. First, each rare variant that caused an amino acid substitution may be scored to yield a score mᵢ. For example, such a score may be generated by the Variant Effect Scoring Tool (VEST) proposed by Carter et al. in “Identifying Mendelian Disease Genes with the Variant Effect Scoring Tool,” BMC Genomics 14 Suppl. 3:S3, the entirety of which is hereby incorporated by reference. Rare truncating (nonsense, nonstop, frameshift) and splice site variants (dⱼ) may be assumed to have on average a larger impact than rare missense variants. These events may be given a score proportional to the highest scoring amino acid substitution variant in the gene and their allele frequency (AF_{dj}) as follows:

dⱼ=maxᵢ{mᵢ}×(1−AF_{d}_{ⱼ}) (Eq. 1)

An assumption may be made that rare variants in a gene were not in linkage disequilibrium and were therefore independent. VEST p-values (e.g., significance values) may then be combined to yield a gene-level statistic:

$${T}_{GENE} = - 2 \times {\sum }_{i = 1}^{N} ln ( {p}_{i} ) \qquad ( Eq . 2 )$$

From this, the probability P(G=1|T_{GENE}) that the gene was functionally altered by all rare variants observed in the individual may be determined using Bayes' Rule, to determine the values of nodes 618-620. As will be appreciated, other scoring mechanisms may be used to score rare variants and genes, according to various other embodiments.

Layer 634—Nodes 622-628 in this layer may be binary random variables that represent sets of hidden mechanisms that account for the clinical phenotype. Said differently, each binary random variable represented by nodes 622-628 may indicate whether the cellular function(s) for the corresponding grouping (e.g., V_{H}, G_{H}, G_{L}, V_{L}) are affected or not.

Layer 636—In this layer, a final random variable 616 (Y) may represent the phenotypic status of the individual. In particular, the joint distribution of nodes 622-628 may be used to infer the state of variable Y. The posterior probability of Y is then outputted by model 600 (e.g., as phenotype probability 318 shown in FIG. 3).

The topology of model 600 yields the following equation for the posterior probability of an individual's phenotypic status, given genome sequence data:

$$\begin{matrix}P ( Y = 1 \vert Data ) = Σ P ( Y = 1 , {S}_{VH} , {S}_{GH} , {S}_{GL} , {S}_{VL} \vert Data ) \\ = Σ P ( Y = 1 , {S}_{VH} , {S}_{GH} , {S}_{GL} , {S}_{VL} ) \\ P ( {S}_{VH} , {S}_{GH} , {S}_{GL} , {S}_{VL} \vert Data ) \\ = Σ P ( Y = 1 , {S}_{VH} , {S}_{GH} , {S}_{GL} , {S}_{VL} ) P ( {S}_{VH} \vert Data ) \\ P ( {S}_{GH} \vert Data ) P ( {S}_{GL} \vert Data ) P ( {S}_{VL} \vert Data )\end{matrix} \qquad ( Eq . 3 )$$

where the summation is over all possible configurations of S_{VH}, S_{GH}, S_{GL} and S_{VL}. The number of penetrance parameters may be reduced by assuming lower penetrance genotypes can be discarded if higher penetrance genotypes are present, as follows:

P(Y=1|S_{VH}=1,S_{GH},S_{GL},S_{VL})=P(Y=1|S_{VH}=1)

P(Y=1|S_{VH}=0,S_{GH}=1,S_{GL},S_{VL})=P(Y=1|S_{VH}=0,S_{GH}=1)

P(Y=1|S_{VH}=S_{GH}=0,S_{GL}=1,S_{VL})=P(Y=1|S_{VH}=S_{GH}=0,S_{GL}=1) (Eq. 4)

(Eq. 3), (Eq. 4) can be rewritten so that the joint distribution of S_{VH}, S_{VL}, S_{GH}, S_{GL} depends only on nine parameters as shown:

$$P ( Y = 1 \vert Data ) = P ( Y = 1 \vert {S}_{VH} = 1 ) P ( {S}_{VH} = 1 \vert Data ) + P ( Y = 1 \vert {S}_{VH} = 0 , {S}_{GH} = 1 ) P ( {S}_{VH} = 0 , {S}_{GH} = 1 \vert Data ) + P ( Y = 1 \vert {S}_{VH} = {S}_{GH} = 0 , {S}_{GL} = 1 ) P ( {S}_{VH} = {S}_{GH} = 0 , {S}_{GL} = 1 \vert Data ) + P ( Y = 1 \vert {S}_{VH} = {S}_{GH} = {S}_{GL} = 0 , {S}_{VL} = 1 ) P ( {S}_{VH} = {S}_{GH} = {S}_{GL} = 0 , {S}_{VL} = 1 \vert Data ) + P ( Y = 1 \vert {S}_{VH} = {S}_{GH} = {S}_{GL} = {S}_{VL} = 0 ) P ( {S}_{VH} = {S}_{GH} = {S}_{GL} - {S}_{VL} = 0 \vert Data ) \qquad ( Eq . 5 )$$

The posterior probabilities of S_{VH}, S_{VL}, S_{GH}, S_{GL} may then be computed as follows:

Estimation of Node 622 (S_{VH}):

Determining the probability that high penetrance variants are affected is fairly straightforward. In particular, this probability is a direct function of whether or not known phenotype causing variants are identified in the genome of the subject:

$$P ( {S}_{VH} = 1 \vert Data ) = \{ \begin{matrix}1 , & annotated variant genotype match \\ 0 , & otherwise\end{matrix} \qquad ( Eq . 6 )$$

Estimation of Node 624 (S_{GH}):

The probability that cellular process(es) involving high penetrance genes are affected may be calculated as follows:

$$P ( {S}_{GH} = 1 \vert Data ) = max \{ \begin{matrix}{max}_{i} \{ P ( {G}_{{H}_{i}} = 1 \vert Data ) \} - {max}_{i} \{ E [ P ( {G}_{{H}_{i}} = 1 ) ] \} \\ 0\end{matrix} \qquad ( Eq . 7 )$$

where P(G_{H}_{ᵢ}=1|Data) is calculated as in (Eq. 24) below and Data is the gene level statistic (Eq. 2). Such a simplifying assumption may be made that, if there are multiple high penetrance genes, the gene with maximum P(G_{H}_{ᵢ}=1|Data) dominates, if it exceeds a baseline.

Estimation of Node 626 (S_{GL}):

The probability that cellular process(es) involving low penetrance genes are affected may be calculated as follows:

$$P ( {S}_{GL} = 1 \vert Data ) = 1 - {[ {\prod }_{i} ( 1 - P ( {G}_{{L}_{i}} = 1 \vert Data ) ) ]}^{{α}_{{S}_{GL}}} \qquad ( Eq . 8 )$$

where P(G_{L}_{ᵢ}=1|Data) is calculated as in (Eq. 24) and Data is the gene level statistic (Eq. 2). If there are multiple low penetrance genes, the combined impact of P(G_{L}_{ᵢ}=1|Data) may be estimated with a noisy- or model, exponentiated by a phenotype-specific weight (α_{S}_{_{GL}}), which controls for ascertainment bias (some phenotypes have hundreds of annotated low-penetrance genes while others have very few annotated low-penetrance genes) (Eq. 15).

Estimation of Node 628 (S_{VL}):

The probability that cellular process(es) involving low penetrance variants are affected may be calculated as follows:

$$P ( {S}_{VL} = 1 \vert Data ) = 1 - {[ {\prod }_{i} {OR}_{i}^{{V}_{{L}_{i}}} ]}^{- {α}_{{S}_{VL}}} \qquad ( Eq . 9 )$$

where ORᵢ is the odds ratio of genotype V_{L}_{ᵢ}ε{0, 1, 2} (e.g., from GWAS database 306).

Ascertainment bias may be controlled with a phenotype-specific weight (α_{S}_{_{VL}})(Eq. 17).

Estimation of Node 622 (S_{VH}) Penetrance:

The penetrance of S_{VH} may be computed as follows:

$$P ( Y = 1 \vert {S}_{VH} = 1 ) = \{ \begin{matrix}0.90 , & \begin{matrix}Homozygous variant genotype or \\ dominant heterozygous genotype\end{matrix} \\ 0.45 , & \begin{matrix}H eterozygous genotype with \\ unknown genetic model\end{matrix}\end{matrix} \qquad ( Eq . 10 )$$

In the absence of quantitative annotations (effect size), it may be estimated that a homozygous variant genotype or heterozygous variant genotype (if the genetic model is dominant) has penetrance of 0.9 and a heterozygous variant genotype has penetrance of 0.45, when the genetic model is unknown. As will be appreciated other values may be used, in other implementations. In one embodiment, blood type, which is a high penetrance variant phenotype (e.g., from database 308), may be used to estimate penetrance based on the genotype of the following SNPs: rs8176719, rs8176746, and rs8176747.

Estimation of Node 628 (S_{VL}) Penetrance:

The penetrance of S_{VL} may be computed as follows:

$$P ( Y = 1 \vert {S}_{VH} = {S}_{GH} = {S}_{GL} = 0 , {S}_{VL} = 1 ) = \frac{1}{n} {\sum }_{i = 1}^{n} P ( Y = 1 \vert {V}_{i} = 1 ) \qquad ( Eq . 11 )$$

where P(Y=1|Vᵢ=1) is computed by (Eq. 23) and n is the total number of low penetrance variants associated with the phenotype.

Estimation of Node 624 (S_{GH}) Penetrance:

The penetrance of S_{GL} may be computed as follows:

$$P ( Y = 1 \vert {S}_{VH} = 0 , {S}_{GH} = 1 ) = \frac{q \times P ( Y = 1 )}{P ( V = 1 )} \qquad ( Eq . 12 )$$

where q is a variable related to

$${k}_{1} \times \frac{1}{n} {\sum }_{i = 1}^{n} {OR}_{i} , \qquad ( Eqs . 20 \text{-} 23 )$$

P(Y=1) is the prevalence of the phenotype for the individual, and P(V=1) is the frequency of a rare variant, estimated as 0.01. k₁=5 based on estimates about the higher penetrance of rare vs. common variants.

Estimation of Node 626 (S_{GL}) Penetrance:

The penetrance of S_{GL} may be computed as follows:

$$P ( Y = 1 \vert {S}_{VH} = {S}_{GH} = 0 , {S}_{GL} = 1 ) = \frac{q \times P ( Y = 1 )}{P ( V = 1 )} \qquad ( Eq . 13 )$$

where q is a variable related to

$${k}_{2} \times \frac{1}{n} {\sum }_{i = 1}^{n} {OR}_{i} , \qquad ( Eqs . 20 \text{-} 23 )$$

P(Y=1) is the prevalence of the phenotype for the individual, and P(V=1) is the frequency of a rare variant, estimated as 0.01, k₂=2 based on estimates about the higher penetrance of rare vs. common variants.

Unknown Factor/Environmental Penetrance:

According to various embodiments, model 600 may also incorporate the penetrance associated with unknown or non-genetic factors, such as environmental conditions. In some embodiments, the prevalence (e.g., from prevalence database 312) may be represented as follows:

$$\begin{matrix}Prevalence = E [ P ( Y = 1 ) ] = \sum P ( Y = 1 \vert Data ) P ( Data ) & \\ = \sum P ( Y = 1 \vert {S}_{VH} , {S}_{GH} , {S}_{GL} , {S}_{VL} ) \times & \\ E [ P ( {S}_{VH} , {S}_{GH} , {S}_{GL} , {S}_{VL} ) ] & \\ = P ( Y = 1 \vert {S}_{VH} = 1 ) \times E [ P ( {S}_{VH} = 1 ) ] + & [ 1 ] \\ P ( Y = 1 \vert {S}_{VH} = 0 , {S}_{GH} = 1 ) \times & \\ E [ P ( {S}_{VH} = 0 , {S}_{GH} = 1 ) + & [ 2 ] \\ P ( Y = 1 \vert {S}_{VH} = {S}_{GH} = 0 , {S}_{GL} = 1 ) \times & \\ E [ P ( {S}_{VH} = {S}_{GH} = 0 , {S}_{GL} = 1 ) ] + & [ 3 ] \\ P ( Y = 1 \vert {S}_{VH} = {S}_{GH} = {S}_{GL} = 0 , {S}_{VL} = 1 ) \times & \\ E [ P ( {S}_{VH} = {S}_{GH} = {S}_{GL} = 0 , {S}_{VL} = 1 ) ] + & [ 4 ] \\ P ( Y = 1 \vert {S}_{VH} = {S}_{GH} = {S}_{GL} = {S}_{VL} = 0 ) \times & \\ E [ P ( {S}_{VH} = {S}_{GH} = {S}_{GL} = {S}_{VL} = 0 ) ] & [ 5 ]\end{matrix} \qquad ( Eq . 14 a )$$

In other words, the overall prevalence of the phenotype may be attributable to the four penetrances associated with nodes 622-628 (equations [1]-[4] above), as well as to any unknown or environmental factors (equation [5] above). Thus, the penetrance of the unknown or environmental factors may be calculated as follows:

$$P ( Y = 1 \vert {S}_{VH} = {S}_{GH} = {S}_{GL} = {S}_{VL} = 0 ) = \frac{[ 5 ]}{E [ P ( {S}_{VH} = {S}_{GH} = {S}_{GL} = {S}_{VL} = 0 ) ]} \qquad ( Eq . 14 )$$

If available, the ratio between [1]+[2]+[3]+[4] and [5] can be determined by heritability. Otherwise, a ratio of 1 or another fixed ratio may be used. In some cases, an assumption may be made that [1]=[2]=0 (E[P(S_{VH}=1)]=E[P(S_{GH}=1)]=0) and [3]=[4]. In other words, it may be assumed that the overall heritability is attributable in equal amounts to the GL and VL categories.

$$\begin{matrix} E [ P ( {S}_{GL} = 1 ) ] = \frac{[ 3 ]}{P ( Y = 1 \vert {S}_{VH} = {S}_{GH} = 0 , {S}_{GL} = 1 )} & ( Eq . 14 b ) \\ E [ P ( {S}_{GL} = 0 , {S}_{VL} = 1 ) ] = \frac{[ 4 ]}{P ( Y = 1 \vert {S}_{VH} = {S}_{GH} = {S}_{GL} = 0 , {S}_{VL} = 1 )} & ( Eq . 14 c )\end{matrix}$$

Assuming S_{GL} and S_{VL} are independent,

$$E [ P ( {S}_{GL} = 0 , {S}_{VL} = 0 ) ] = E [ P ( {S}_{GL} = 0 ) ] E [ P ( {S}_{VL} = 0 ) ] = ( 1 - E [ P ( {S}_{GL} = 1 ) ] ) ( 1 - \frac{E [ P ( {S}_{GL} = 0 , {S}_{VL} = 1 ) ]}{1 - E [ P ( {S}_{GL} = 1 ) ]} ) \qquad ( Eq . 14 d )$$

In some cases, the posterior probabilities of S_{VL} (Eq. 8) and S_{GL} (Eq. 9) are likely to be confounded by ascertainment bias, given the wide range of annotated variants and genes available for different phenotypes in data sources 104. In such cases, two weights, α_{S}_{_{GL}} and α_{S}_{_{VL}}, computed with numerical optimization, may be incorporated to control this bias. These weights may be calculated as follows:

$$E [ P ( {S}_{GL} = 1 ) = 1 - {\prod }_{i} E [ {( 1 - P ( {G}_{{L}_{i}} = 1 ) )}^{{a}_{{s}_{GL}}} ] \qquad ( Eq . 15 )$$

The value of α_{S}_{_{GL}} may then be determined by equating equations (Eq. 14b) and (Eq. 15) and solving for α_{S}_{_{GL}}.

### According to (Eq. 14b) and (Eq. 14c),

$$\begin{matrix}E [ P ( {S}_{VL} = 1 ) ] = \frac{E [ P ( {S}_{GL} = 0 , {S}_{VL} = 1 ) ]}{1 - E [ P ( {S}_{GL} = 1 ) ]} and & ( Eq . 16 ) \\ \begin{matrix}E [ P ( {S}_{VL} = 1 ) ] = 1 - {\prod }_{i} E [ {( {( {OR}_{i} )}^{{V}_{{L}_{d}}} )}^{- {α}_{{s}_{VL}}} ] \\ = 1 - {\prod }_{i} {\sum }_{j ∈ \{ 0 , 1 , 2 \}}^{□} {( {OR}_{i} )}^{- j {α}_{{s}_{VL}}} P ( {V}_{{L}_{i}} = j )\end{matrix} & ( Eq . 17 )\end{matrix}$$

The value of α_{S}_{_{VL}} may then be determined by equating equations (Eq. 16) and (Eq. 17) and solving for α_{S}_{_{VL}}. In some embodiments, optimization may also be performed by imposing the following constraints for numerical stability:

0≦α_{S}_{_{VL}}≦1 and 0≦α_{S}_{_{GL}}≦1 (Eq. 18)

Computation of α_{S}_{_{GL}} and α_{S}_{_{VL}} in equations (Eq. 15) and (Eq. 17) may require estimates of expected values for the frequency of functionally impacted low penetrance genes and the odds ratios of hits associated with the phenotype (e.g., from GWAS database 306). In one embodiment, these expected values may be estimated using data regarding variants in the general population (e.g., from data sources 104). For example, such information may be retrieved from a database such as the Exome Variant Server ESP6500, the 1000 Genomes Project, or other such database. Using the variant data, all rare variants (e.g., those having <1% MAF, etc.) may be identified for the selected genes and their population frequencies, and then used to compute functional impact scores (Eq. 2). Next, for each gene, a population of subjects may be simulated (e.g., 1,000 individuals, 10,000 individuals, or another size), to match the frequency spectrum of the identified rare variants. In some cases, it may be assumed that rare variants within a gene are not in linkage disequilibrium. For each member of the population, P(G_{L}=1|Data) may be caluclated, to form an estimate for equation (Eq. 15). The allele frequency for each GWAS hit (e.g., from GWAS database 306) in the variant data (e.g., for coding and/or non-coding variants) may then be determined. These frequencies may then be used to compute equation (Eq. 17) based on the assumption of Hardy-Weinberg equilibrium.

In some cases, data regarding the estimated penetrance of a phenotype may not be available from data sources 104. However, a GWAS odds ratio may still be available (e.g., from GWAS database 306). According to some embodiments, such an odds ratio may be converted into a penetrance value using estimates of genotype population frequencies and phenotype prevalence, as follows. First, let the binary random variables V and Y represent a variant genotype and a phenotype of interest. By definition,

$$OR = \frac{P ( V = 1 \vert Y = 1 ) / ( 1 - P ( V = 1 \vert Y = 1 ) )}{P ( V = 1 \vert Y = 1 ) / ( 1 - P ( V = 1 \vert Y = 0 ) )} \qquad ( Eq . 19 )$$

Equation (Eq. 19) may be rewritten by setting the numerator to q/(1−q) and the denominator to p/(1−p), leading to the following:

$$OR = \frac{q / ( 1 - q )}{p / ( 1 - p )} = \frac{q - qp}{p - qp} . \qquad ( Eq . 20 )$$

This gives the following:

$$\begin{matrix}OR \times p - q = ( OR - 1 ) \times qp & ( Eq . 21 ) \\ \begin{matrix}P ( V = 1 ) = P ( V = 1 , Y = 0 ) + P ( V = 1 , Y = 1 ) \\ = P ( V = 1 \vert Y = 0 ) P ( Y = 0 ) + \\ P ( V = 1 \vert Y = 1 ) P ( Y = 1 ) \\ = p \times P ( Y = 0 ) + q \times P ( Y = 1 )\end{matrix} & ( Eq . 22 )\end{matrix}$$

The term P(V=1) represents the population frequency of the variant genotype V. In one embodiment, this term may be estimated by counting how often V occurs in the variant data for the general population. According to some embodiments, the variant data may be further tailored to a particular subject based on the demographics of the subject (e.g., using demographics 316). For example, the frequency of the variant may be identified for Northern Europeans, if the subject belongs to this population.

Determining Phenotype Probability

As noted previously, statistical model 600 may be used to estimate the phenotype probability for the subject (e.g., phenotype probability 318). Let the term P(Y=1) represent the frequency of the phenotype, or its prevalence. According to various embodiments, the estimated phenotype prevalence for a subject may be determined by also taking into account the demographics of the individual (e.g., demographics 316, such as the age, gender, self-reported ancestry, etc. of the subject). The penetrance can then be computed using Bayes' rule by solving for q as follows:

$$P ( Y = 1 \vert V = 1 ) = \frac{q \times P ( Y = 1 )}{P ( V = 1 )} \qquad ( Eq . 23 )$$

The probability that a gene is functionally altered in an individual may then be determined as follows, according to some embodiments:

$$P ( G = 1 \vert {T}_{GENE} ) = \frac{P ( {T}_{GENE} \vert G = 1 ) P ( G = 1 )}{P ( {T}_{GENE} \vert G = 1 ) P ( G = 1 ) + P ( {T}_{GENE} \vert G = 0 ) P ( G = 0 )} \qquad ( Eq . 24 )$$

where T_{GENE}=−2×Σᵢ₌₁^{N} ln(pᵢ) and pᵢ is the VEST p-value of each variant i in the gene and P(T_{GENE}|G=1) is estimated with simulation, based on empirical data.

In some cases, it may be assumed that a single rare functional variant in a gene is sufficient for the function of that gene's translated product to be altered. Based on this assumption, the distribution of T_{GENE} in a sample of genes having one rare functional variant and N−1 benign variants may be determined (e.g., varying N from to 1 to 50, etc.). P(T_{GENE}|G=1) may be estimated by generating a set of functionally altered genes (e.g., 1,000 genes, 10,000 genes, etc.), each of which contains one rare functional variant randomly drawn from the GH class of data and N−1 rare variants randomly drawn from the variant data. P(T_{GENE}|G=0) may also be estimated by generating a set of genes that are not functionally altered (e.g., 1,000 genes, 10,000 genes, etc.), using N number of randomly drawn rate variants. In some cases, a uniform prior may be assumed, leading to the following:

P(G=1)=P(G=0)=0.5 (Eq. 25)

As will be appreciated, model 600 is dependent on the data available from data sources 104. For example, incomplete data and/or incorrect annotations in data sources 104 may affect the overall performance of model 600. As described above, a number of assumptions may be made regarding the penetrance parameters of model 600. However, if data source 104 is available that provides the genomes and phenotypic profiles of a large number of people, this data may be used to determine a maximum likelihood estimation of the penetrance parameters in model 600, in some embodiments. Such a data source may allow the generation of reference panels for adult genetic testing. Model 600 may then be used to compute the posterior probability of each sequenced individual for each phenotype of interest and generate ranked lists consisting of hundred or even thousands of subjects. As the lists grow larger, they would also grow in utility for individuals who learn their ranks within the lists. In some embodiments, model 600 may also be extended to include genomic copy number variations, data from microbiomes, or even a model that describes gene-gene interactions.

In various embodiments, any of nodes 622-628 in layer 634 shown in FIG. 6 may be excluded from model 600. In other words, a particular node in nodes 622-628 may be excluded if a test set of data for a given phenotype indicates that the node/sub-model does not improve the results of model 600. For example, nodes 626, 628 may be dropped when model 600 is used to predict Mendelian diseases.

An example simplified procedure 700 for predicting the expression of a phenotype by a subject is shown, according to various embodiments. Procedure 700 may begin at a step 705 and continue on to step 710 where, as described in greater detail above, a statistical model is generated for a phenotype. According to various embodiments, the statistical model may be a Bayesian inference model that incorporates data from any number of data sources. In one embodiment, the model may use population-level prevalence data as a prior. In another embodiment, the model may take into account the contributions of rare and variant genotypes of a subject. In yet another embodiment, the model may consider the effects of unknown factors to which the population-level prevalence is attributable, such as environmental and unknown risk factors.

At step 715, data regarding a subject (e.g., genotype, (epi)genetic, and/or other omics data regarding the subject) is received and procedure 700 continues on to step 720 where the received data is used as an input to the model. In some embodiments, demographics data for the subject may also be received and used as an input to the model. For example, population-level prevalence used as a prior in the model may be adjusted based on the actual demographics of the subject under analysis.

At step 725, a phenotype probability is determined by the model, as described in greater detail above. In particular, the model may match both genes and variants present in the received (epi)genome and/or microbiome of the subject to known genes and variants indicated in the various data sources. The various sources of data may be categorized and used as part of sub-models, to determine the phenotype probability of the subject. For example, the various sources of data may be categorized by the type of information contained in the data source (e.g., variant vs. gene data) and/or whether the degree of penetrance associated with the data (e.g., high penetrance vs. low penetrance). Based on the match between the (epi)genome and/or microbiome of the subject and the generated probabilities of these categories, the phenotype probability may be inferred within the model.

At step 730, the phenotype probability is then provided to another electronic device. In some embodiments, the phenotype probability is provide to a user interface device, such as an electronic display, printer, or other device configured to present data to a user. For example, the determined phenotype probability may be provided as part of a report for the subject that incorporates probabilities for any number of different phenotypes. In some embodiments, the actual phenotype probability may be provided. In other embodiments, the phenotype probability may be represented in another form (e.g., to make assessment by the user easier). For example, the phenotype probability may be ranked among a set of phenotypes, to indicate the most probable phenotypes of the subject given the (epi)genome and/or microbiome of the subject. Procedure 700 then ends at step 735.

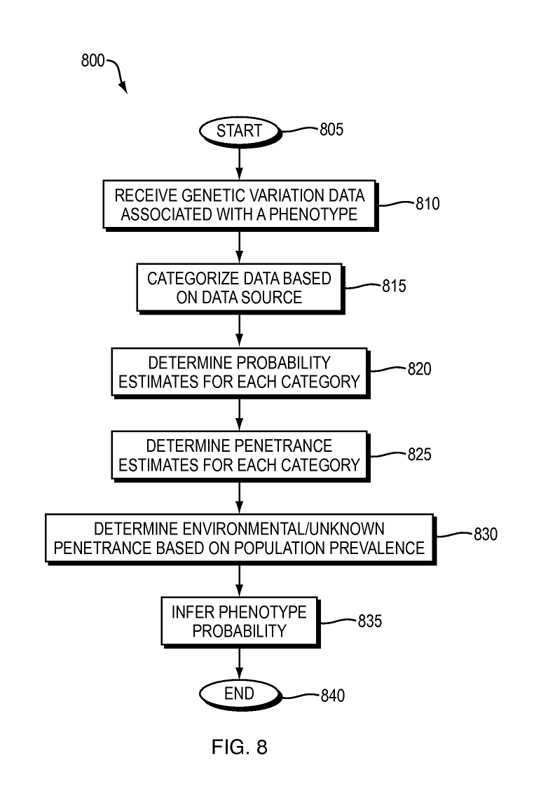

FIG. 8 illustrates an example simplified procedure 800 for generating a statistical model, according to various embodiments. Procedure 800 may start at a step 805 and continue on to step 810 where, as described in greater detail above, genetic variation data associated with a phenotype may be received from any number of data sources. For example, as shown in FIG. 3, scripts may be executed by a computing system to retrieve genetic variation data from any number of online data sources. Such databases may include, but are not limited to, databases that contain GWAS data, databases that contain listings of variations and/or genes with associated annotations (e.g., annotations that indicate a link between a phenotype and a variation or gene), databases that include listings of rare variants within a population, search engines that search academic publications, combinations thereof, or the like.

At step 815, the data received in step 810 may be categorized based on its corresponding type or source. As described in greater detail above, the different data sources may include varying information regarding the link between a phenotype and a particular gene or variant. For example, an annotation associated with a particular variant may indicate whether the phenotype exhibits a high or low penetrance when the variant is present. In some embodiments, rare variants corresponding with genes present in an (epi)genome and/or microbiome of a subject may be analyzed within the model to estimate the penetrance of the phenotype with respect to the rare variants. For example, rare variants that exhibit a MAF<0.01 for a population may be assessed in the model as part of high and low penetrance/gene categories within the model.

At step 820, probability estimates are determined for each category of data used in the model. As described in greater detail above, each category of data may be treated as a binary random variable. The probabilities of each random variable may then be determined according to their various categories. For example, the probability of a high penetrance variant category may be one if the (epi)genome and/or microbiome of the subject matches a variant annotated as such in the data received in step 810. Otherwise, the probability of the high penetrance variant category may be zero.

At step 825, penetrance estimates for each category may be determined. As described in greater detail above, different penetrance estimates may be performed for the different categories. For example, in the case of a high penetrance variant category, the estimated penetrance may be a function of whether the variant corresponds to a homozygous risk allele, dominant heterozygous allele, or a heterozygous allele with an unknown genetic model. In some embodiments, the penetrance estimates for other categories may be based in part on odds ratios, such as those typically found in GWAS results.

At step 830, as described in greater detail above, a penetrance estimate may be determined for unknown or environmental causes based in part on population prevalence data. In various embodiments, the penetrance attributable to unknown or environmental causes may be determined as the difference between the population prevalence and the contributions of the various categories from step 815 on the population prevalence. In one embodiment, the population prevalence may be associated with a particular demographic and/or geographic location.

At step 835, a phenotype probability is inferred from the penetrance estimates determined in steps 825-830 based on the (epi)genome and/or microbiome of a given subject, as described in greater detail above. In particular, the (epi)genome and/or microbiome of the subject may be used as inputs to the model, to calculate a posterior, while taking into account the population prevalence as a prior. Procedure 800 then ends at step 840.

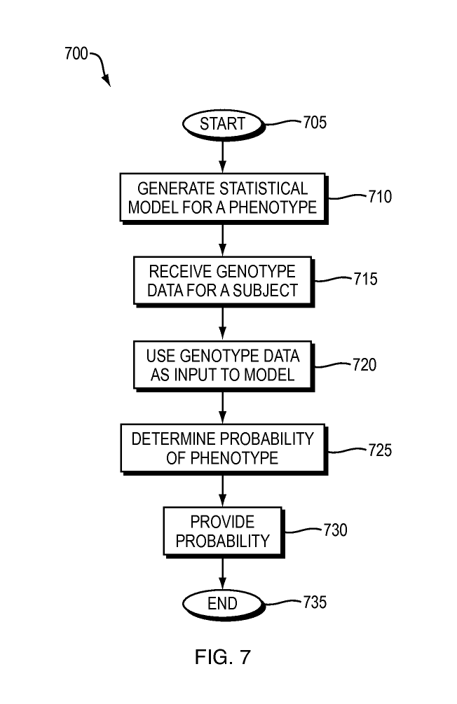

It should be noted that while certain steps within procedures 700-800 may be optional as described above, the steps shown in FIGS. 7-8 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures 700-800 are described separately, certain steps from each procedure may be incorporated into each other procedure, and the procedures are not meant to be mutually exclusive.

The techniques described herein, therefore, provide for a statistical model that predicts the presence of a phenotype (e.g., disease, disorder, talent, trait, etc.) in a subject based on the (epi)genome and/or microbiome of the subject. In some aspects, the model may incorporate data from any number of online data sources. Such data may be categorized within the model and treated differently, according to their respective data sources and the provided information. In further aspects, the different categories may be assessed and modeled in sub-models, to determine their potential effects. In yet another aspect, the model may further take into account unknown factors (e.g., environmental, etc.) by assessing the prevalence of the phenotype within a population.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
generating, by a computing device, a statistical model for a phenotype, wherein the statistical model uses a population prevalence of the phenotype as a prior probability;
receiving, at the computing device, data regarding the subject;
using the data regarding the subject as input to the statistical model;
determining, by the statistical model, a probability of the phenotype for the subject; and
providing, by the computing device, the probability of the phenotype for the subject.

2. The method of claim 1, wherein the probability of the phenotype for the subject is based in part on an estimated effect of unknown or environmental factors on the population prevalence.

3. The method as in claim 1, wherein the statistical model is a Bayesian inference model.

4. The method as in claim 1, wherein the statistical model is generated by:
receiving, from a plurality of data sources, genetic variation data associated with the phenotype.

5. The method as in claim 4, wherein the genetic variation data associated with the phenotype comprises one or more of: genome-wide association study data, an annotated gene identifier, an annotated variant identifier, or rare variant data.

6. The method as in claim 4, wherein the statistical model is further generated by:
categorizing the genetic variation data into categories comprising two or more of the following: a high penetrance variant category, a low penetrance variant category, a high penetrance gene category, and a low penetrance gene category.

7. The method as in claim 1, wherein the statistical model assumes gene independence.

8. The method as in claim 1, wherein the probability of the phenotype is provided to a user interface device.

9. An apparatus, comprising:
one or more network interfaces to communicate with a network;
a processor coupled to the network interfaces and adapted to execute one or more processes; and
is a memory configured to store a process executable by the processor, the process when executed operable to:
generate a statistical model for a phenotype, wherein the statistical model uses a population prevalence of the phenotype as a prior probability;
receive data regarding a subject;
use the data regarding the subject as input to the statistical model;
determine a probability of the phenotype for the subject; and
provide the probability of the phenotype for the subject.

10. The apparatus of claim 9, wherein the probability of the phenotype for the subject is based in part on an estimated effect of unknown or environmental factors on the population prevalence.

11. The apparatus of claim 9, wherein the statistical model is a Bayesian inference model.

12. The apparatus of claim 9, wherein the statistical model is generated by:
receiving, from a plurality of data sources, genetic variation data associated with the phenotype.

13. The apparatus of claim 12, wherein the genetic variation data associated with the phenotype comprises one or more of: genome-wide association study data, an annotated gene identifier, an annotated variant identifier, or rare variant data.

14. The apparatus of claim 12, wherein the statistical model is further generated by:
categorizing the genetic variation data into categories comprising two or more of the following: a high penetrance variant category, a low penetrance variant category, a high penetrance gene category, and a low penetrance gene category.

15. The apparatus of claim 9, wherein the statistical model assumes gene independence.

16. A tangible, non-transitory, computer-readable media having software encoded thereon, the software when executed by a processor operable to:
generate a statistical model for a phenotype, wherein the statistical model uses a population prevalence of the phenotype as a prior probability;
receive data regarding a subject;
use the data regarding the subject as input to the statistical model;
determine a probability of the phenotype for the subject; and
provide the probability of the phenotype for the subject.

17. The computer-readable media of claim 16, wherein the probability of the phenotype for the subject is based in part on an estimated effect of unknown or environmental factors on the population prevalence.

18. The computer-readable media of claim 16, wherein the statistical model is a Bayesian inference model.

19. The computer-readable media of claim 16, wherein the statistical model is generated by:
receiving, from a plurality of data sources, genetic variation data associated with the phenotype.

20. The computer-readable media of claim 19, wherein the genetic variation data associated with the phenotype comprises one or more of: genome-wide association study data, an annotated gene identifier, an annotated variant identifier, or rare variant data.
